(19) United States
(12) Patent Application Publication
(10) Pub. No.: US 2012/0320150 A1
(43) Pub. Date: Dec. 20, 2012

(54) MULTI-LENS, 360-DEGREE TIME LAPSE CAMERA

(76) Inventor: Myles MONTGOMERY, Cumming, GA (US)

(21) Appl. No.: 13/483,946

(22) Filed: May 30, 2012

Related U.S. Application Data
(60) Provisional application No. 61/497,118, filed on Jun. 15, 2011.
(60) Provisional application No. 61/510,288, filed on Jul. 21, 2011.

(51) Int. Cl. H04N 5/225; H04N 7/015

(52) U.S. Cl. 348/36; 348/E07.004; 348/E05.025

(57) ABSTRACT

A multi-lens, 360 degree time lapse camera is preferably a compact, mobile camera that is designed to capture pictures of entire 360 degree surroundings. In example embodiments, the camera unit is constructed of molded plastic and can be located at any desired location. The camera unit comprises a multi-lens HD camera, a hinged cap, a programmable camera control settings panel, multiple USB flash drive memory ports, a standard screw camera bracket attached to a threaded cap, an optional antenna for wireless monitoring, a connector to hardwire camera for networked pc monitoring, a telescoping support rod, a threaded pointed stake and a wall/tree/post mounting bracket.

### CROSS-REFERENCE TO RELATED APPLICATIONS

This application claims the benefit of U.S. Provisional Patent Application Ser. No. 61/497,118 filed Jun. 15, 2011, and U.S. Provisional Patent Application Ser. No. 61/510,288 filed Jul. 21, 2011, the entireties of which are hereby incorporated herein by reference for all purposes.

### TECHNICAL FIELD

The present invention relates generally to a compact, multi-lens, 360 degree time lapse camera for scouting wildlife, home security, or other surveillance monitoring.

### BACKGROUND

While various forms of scouting, security and surveillance cameras are known, continued improvement in the field is sought. Therefore, it is to the provision of an improved multi-lens, 360 degree time lapse camera that the present invention is primarily directed.

### SUMMARY

In example embodiments, the present invention provides an improved multi-lens, 360 degree time lapse camera. In one aspect, the present invention relates to a multi-lens, 360 degree wildlife scouting camera including a time lapse multi-lens HD camera 11.0, a hinged waterproof cap 10.0, a programmable camera control settings panel 35.0, multiple USB flash drive memory ports 19.0, a standard screw camera bracket attached to a threaded cap 13.0, an optional transmitter and antenna for wireless monitoring 12.0, a connector to hardwire camera for networked pc monitoring 21.0, a telescoping support rod 15.0-16.0, a threaded pointed stake 18.0 and a wall/tree/post mounting bracket 22.0-25.0.

In another aspect, the invention relates to multi-lens, 360 degree security surveillance camera 11.0.

In still another aspect, the invention relates to a multi-lens, 360 degree surveillance camera with an optional transmitter and antenna for wireless monitoring 11.0-12.0.

In still another aspect, the invention relates to a multi-lens, 360 degree security surveillance camera with an optional hardwiring for networked monitoring 11.0 & 21.0.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1.0 is a perspective view of a multi-lens, 360 degree time lapse camera according to an example embodiment of the invention 10.0-35.0.

FIG. 2.0 is a perspective view of the multi-lens, 360 degree time lapse camera setting features and controls 28.0-35.0.

FIG. 3.0 is a perspective view of the mounting bracket to be used when mounting the multi-lens, 360 degree time lapse camera to a wall, tree or post 22.0-27.0.

FIG. 4.0 shows another embodiment of a camera system according to an example form of the invention.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

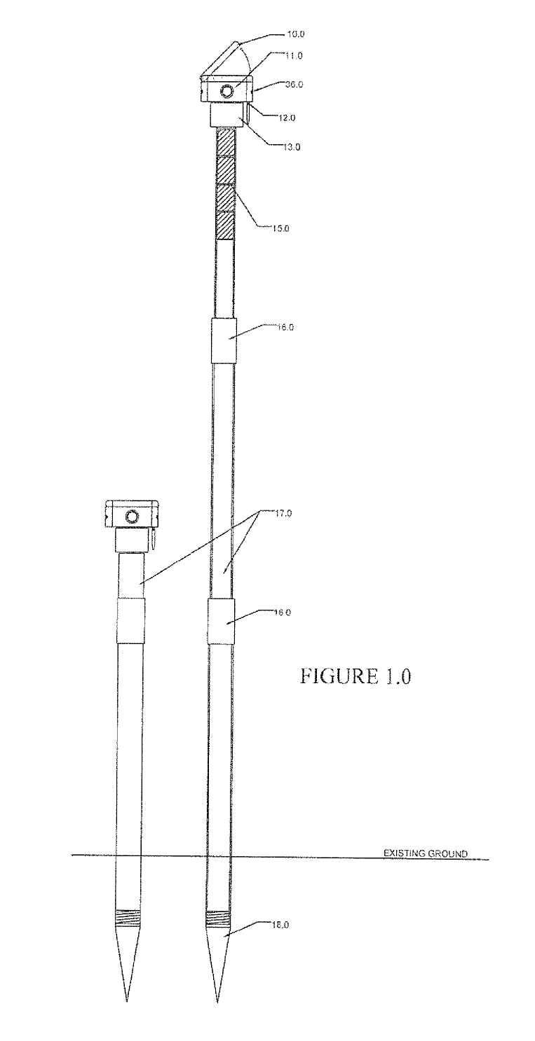

With reference now to the drawing figures, wherein like reference numbers represent corresponding parts throughout the several views, FIGS. 1.0-3.0 show a multi-lens, 360 degree time lapse camera generally comprising a multi-lens HD camera 11.0, a hinged waterproof cap 10.0, a programmable camera control settings panel 35.0, multiple USB flash drive memory ports 19.0, a standard screw camera bracket attached to a threaded cap 13.0, an optional transmitter and antenna for wireless monitoring 12.0, a connector to hardwire camera for networked pc monitoring 21.0, a telescoping support rod 15.0-16.0, a threaded pointed stake 18.0 and a wall/tree/post mounting bracket 22.0-25.0.

The multi-lens 360 degree time lapse camera is preferably a compact, mobile camera that is designed to capture pictures of entire multi-lens, 360 degree surroundings. In example embodiments, the camera unit is constructed of molded plastic and can be located at any desired location. The camera unit comprises a multi-lens HD camera 11.0, a hinged waterproof cap 10.0, a programmable camera control settings panel 35.0, multiple USB flash drive memory ports 19.0, a standard screw camera bracket attached to a threaded cap 13.0, an optional transmitter and antenna for wireless monitoring 12.0, a connector to hardwire camera for networked pc monitoring 21.0, a telescoping support rod 15.0-16.0, a threaded pointed stake 18.0 and a wall/tree/post mounting bracket 22.0-25.0.

In example forms of the invention, the camera is to be powered by batteries that are located outside the multi-lens, 360 degree camera housing.

In example forms of the invention, the entire camera unit can be fitted with an exterior adhesive wrap with a surface texture and/or coloration and finish to match the environment of determined use.

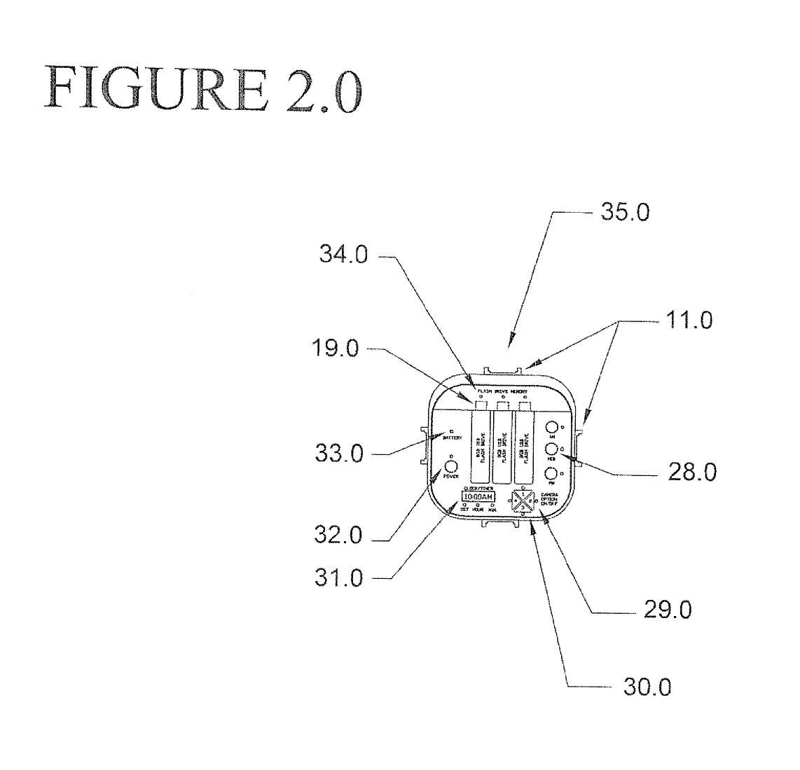

In example embodiments, an integrated circuit processor chip, powered by multiple “D” Cell batteries 15.0, will control a multi-lens HD camera 11.0. Each camera lens will capture a single picture, taken at a timed interval, and stored on a USB Flash Drive Memory Drive 19.0. Each camera lens can be turned on/off by buttons 29.0 found on the control settings panel 35.0 located under the hinged waterproof lid 10.0. This set up will allow the user to select which, if not all, camera lens is to take pictures. The camera run time will be controlled by selecting AM, MID or PM time of operation 28.0. AM, MID and PM are predetermined interval times of operation controlled by internal clock/timer 31.0. A battery life display light 33.0 indicating battery life will warn user when it is time to change batteries. A power display light 32.0 will indicate when camera is in use. For each USB port there will be a flash drive memory display light 34.0 indicating the storage capacity of flash drive. When flash drive is full, light will come on, prompting flash drive needs to be changed. A rubber gasket 30.0 is to be placed under the hinged lid 10.0 to waterproof the control panel 35.0 and electronic working parts of the camera unit as shown in FIG. 2.0. The multi-lens, 360 degree time lapse camera is to be attached to a mounting bracket 13.0 by means of standard screw. This mounting bracket is attached to a threaded cap 13.0, which is to be screwed on to the telescoping support rod containing the multiple “D” cell batteries 14.0. The telescoping support rod can be adjusted from heights of 3′ minimum to 6′ maximum 17.0. The top section will contain the multiple D cell batteries 14.0. The lower section will have an opening which the pointed stake 18.0 is to be installed as shown in FIG. 1.0.

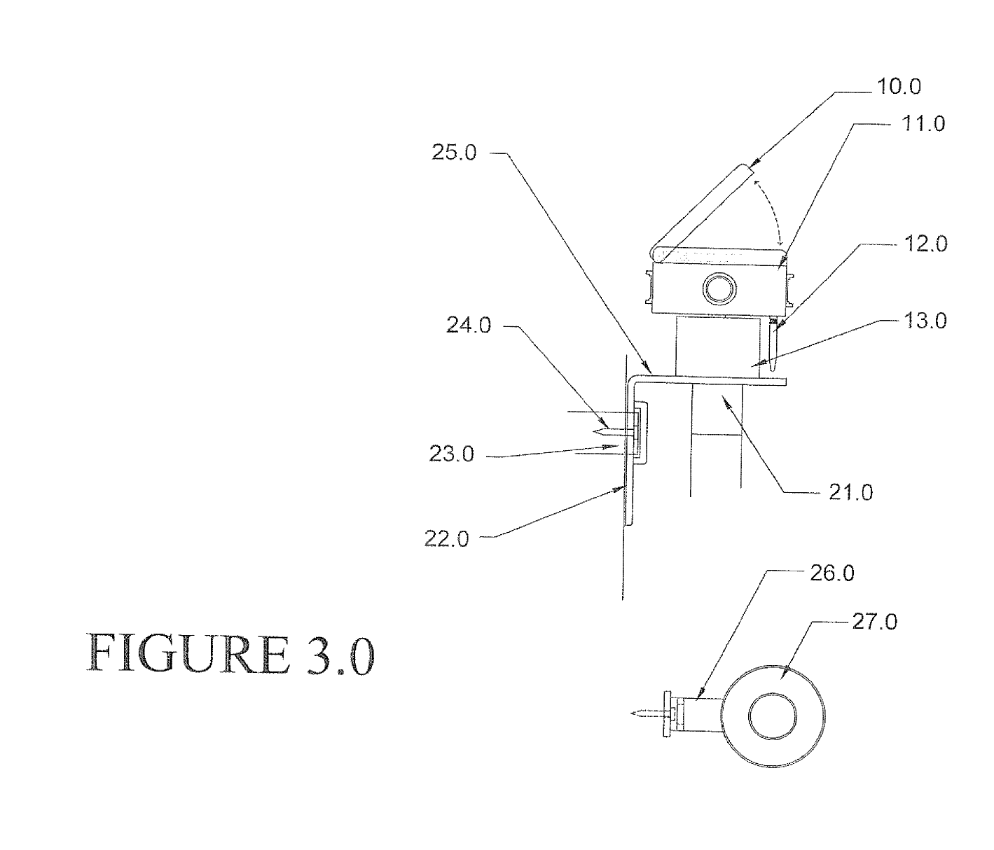

In example embodiments, the multi-lens, 360 degree time lapse camera can be mounted to a wall, tree or post by means of a mounting bracket 22.0-25.0 as shown in FIG. 3.0. The mounting bracket can be attached to a tree or post by running a ratchet strap 23.0 through the slot provide and then tightened. The mounting bracket can also be attached to an interior or exterior wall or post 24.0 by a screw or nail being driven through a drilled opening located in the bracket plate as shown in FIG. 3.0.

In example embodiments, the multi-lens, 360 degree time lapse camera unit can be set up at any desired location. With reference to FIG. 1.0, the pointed stake 18.0 will not require the cameras telescoping support rod system 16.0 to be attached to a fixed object.

In example embodiments, the multi-lens, 360 degree time lapse camera can be hardwired for power supply and/or transferring images 29.0.

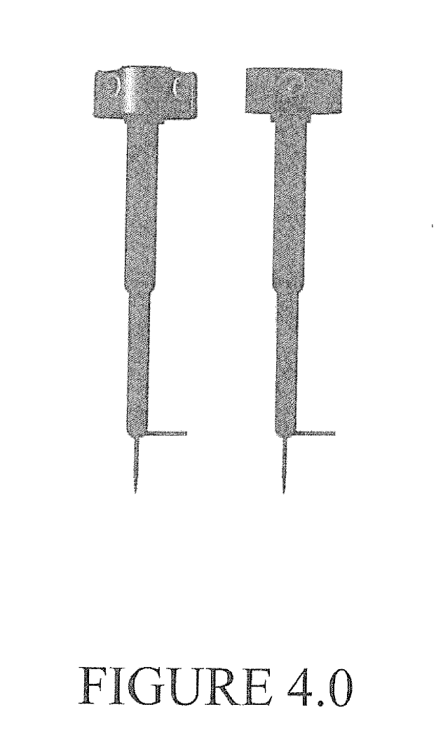

In an alternate embodiment shown in example form in FIG. 4.0, the multi-lens, 360 degree time lapse camera, is shown with a three lens configuration and plastic external housing. It can also be staked into the ground by means of a foot-spike attachment.

Further alternate embodiments within the scope of the invention optionally comprise one or more of the following, in various combination(s) or subcombination(s):
Camera housing, support rod, support stake, ground stakes, anchor bracket and tree/wall mounting bracket to be constructed out of a plastic material or metal.
Camera exterior finish can be smooth, colored, textured or have a camouflage print placed on it.
More than one USB flash drive can be installed for extra storage capacity.
Camera can be powered by batteries, solar panels or electricity.
Camera mounting bracket can be connected to a tree or post by means of ratchet strap, can be mounted to an interior/exterior wall, free standing, hung from a tree limb or metal pole hanger (i.e. hanging plant basket holder).
Camera can be used by ranchers/farmers for monitoring livestock.
Camera antenna can send images to cell phones or personal computers by means of wireless cell tower signals.
Telescoping support rod has the potential of inserting additional rod sections for greater heights.
Camera can be attached to a wildlife game feeder.
Camera can be hung from a limb of a tree by means of straps or support basket.
Solar panel can be built into camera unit or attached to unit to recharge batteries or power other accessories.
Top cap can be designed to allow for placement of other wildlife feed or attractants.
Camera timer settings could be controlled by means of a photocell timer. Recording times at sunrise and sunset.
Camera can provide a motion detector coupled with infrared, black or strobe flash for capturing images at night.
Unit can be used as commercial or residential security camera.
Construction companies can use the camera to monitor job sites.
Organizations like National Park Service, Department of Natural Resources, Border Patrol or Homeland Security could benefit by using a mobile 360 degree time lapse camera.
Cameras wireless technology will be that of PC Base or Cellular Base type.
Camera could be constructed in a two, three or four lens configuration setup.

While the invention has been described with reference to preferred and example embodiments, it will be understood by those skilled in the art that a variety of modifications, additions and deletions are within the scope of the invention, as defined by the following claims.

What is claimed is:

1. A 360 degree wildlife scouting camera including a time lapse multi-lens HD camera, a hinged waterproof cap, a programmable camera control settings panel, multiple USB flash drive memory ports, a standard screw camera bracket attached to a threaded cap, an optional antenna for wireless monitoring, a connector to hardwire camera for networked pc monitoring, a telescoping support rod, a threaded pointed stake and a wall/tree/post mounting bracket.

2. A 360 degree security surveillance camera.

3. A 360 degree surveillance camera with an optional antenna for wireless monitoring by pc or cellular technology.

4. A 360 degree security surveillance camera with an optional hardwiring for networked pc monitoring.
